(19) United States
(12) Patent Application Publication
(10) Pub. No.: US 2010/0300079 A1
(43) Pub. Date: Dec. 2, 2010

(54) OPERATION OF DIESEL/LEAN-BURN ENGINES HAVING EASILY REGENERATED PARTICLE FILTERS IN THE EXHAUST SYSTEMS THEREFOR

(76) Inventors: Virginie Harle, Senlis (FR); Laurent Rocher, Vernioz (FR)

Correspondence Address: BUCHANAN, INGERSOLL & ROONEY PC, POST OFFICE BOX 1404, ALEXANDRIA, VA, 22313-1404, US

(21) Appl. No.: 12/529,054

(22) PCT Filed: Feb. 28, 2008
(86) PCT No.: PCT/EP08/52415

§ 371 Date: Aug. 19, 2010

(30) Foreign Application Priority Data
Mar. 6, 2007 (FR) 0701619

(51) Int. Cl. F01N 3/035; F02B 43/00

(52) U.S. Cl. 60/297; 123/1 A

(57) ABSTRACT

Diesel or lean-burn engines which are fitted with an exhaust system provided with a particle filter are supplied with a fuel containing an additive capable of lowering the temperature at which the soot particles trapped by the particle filter can be burned and which essentially consists of an iron compound or essentially consists of an iron compound and of a cerium compound, and wherein the particle filter through which the exhaust gases produced by the combustion of the fuel in the engine pass is a catalytic filter in which the catalyst assists with the combustion of the soot particles; this improves soot combustion dynamics, particularly at low temperatures.

The present invention relates to a method of operating a diesel engine or a lean-burn engine with a view to making it easier to regenerate the particle filter mounted in the exhaust system with which this engine is equipped.

It is known that when diesel oil is burnt in the diesel engine, the carbon-containing products have a tendency to form soot, which is deemed to be harmful both to the environment and to health. Techniques that allow the emissions of these carbon-containing particles, and which in the remainder of the description will be known as “soot” to be reduced have long been sought.

The technique most commonly adopted for doing this is to fit into the exhaust circuits a particle filter (PF) capable of stopping all or a very high proportion of the soot generated by the combustion of the various fuels.

However, as it gradually builds up in the filters, the soot first of all causes an increase in the pressure drop and then causes the filter to begin to be plugged, leading to a loss of engine performance. It is therefore necessary to burn the soot collected by these filters. This operation, which is known as “filter regeneration”, has to be performed regularly.

It should be noted that the temperature (around 650° C.) at which soot can be burnt is far higher than the temperature of the exhaust gases which therefore means that, in order to carry out this regeneration, techniques have to be implemented that allow this temperature to be reached, or lowered.

Thus, it is possible to introduce into the soot and, notably by way of additives in the fuel, catalysts which allow self-ignition of this soot at temperatures of below 500° C.

It is also possible to carry out regeneration by periodically performing a post-injection of fuel into the cylinders of the engine during their expansion phase. This post-injection has the effect of increasing the temperature of the exhaust gases and the amount of hydrocarbons contained therein. These hydrocarbons are converted, on an oxidation catalytic converter positioned upstream of the PF, by an exothermal reaction which therefore raises the exhaust gases to a temperature high enough to burn the soot when these gases reach the bed of soot in the PF.

It will be appreciated that it is advantageous to be able to decrease the frequency and duration of these regenerations and also to be able to perform them at a lower temperature, because this, on the one hand, would lead to a reduction in vehicle fuel consumption as less fuel would be used up for the post-injection phase and, on the other hand, it would make it possible to use in the PFs materials which did not need to have such a high temperature resistance as, for example, silicon carbide, and therefore materials that were less expensive.

The object of the invention is to develop a method of operating diesel engines or lean-burn engines that is able to meet this need.

To this end, the method of the invention is a method of operating a diesel engine or a lean-burn engine equipped with an exhaust system in which a particle filter is mounted, and this method is characterized in that the engine is supplied with a fuel containing an additive capable of lowering the combustion temperature of the particles of soot held by the particle filter and consisting essentially of an iron compound or essentially of an iron compound and of a cerium compound, and in that, by way of particle filter through which the exhaust gases produced by the combustion of the fuel in the engine are passed, use is made of a catalytic filter, the catalyst of which consists of a catalyst that assists with the combustion of the particles of soot.

The method of the invention makes it possible to speed up the combustion of soot, particularly at low temperature, for example at a temperature of below 450° C. Under certain driving conditions in which the exhaust gases have a temperature of at least 240° C., the method of the invention allows the soot to be burnt continuously, thus slowing the filling of the PF and therefore reducing the frequency of regenerations.

Other features, details and advantages of the invention will become more fully apparent upon reading the description which will follow, and from the various concrete but nonlimiting examples intended to illustrate it.

The invention applies to diesel engines or to lean-burn gasoline engines (in which the fuel/oxidant ratio, also known as the richness, is lower than the stoichiometric ratio). These engines are, in the known way, fitted with an exhaust system or muffler into which a PF is incorporated. Conventionally, this is a filter of the kind with a filtering ceramic wall, for example made of cordierite, or of silicon carbide, through which the exhaust gases flow. However, it could just as easily be one or more screens of metal gauze or alternatively a filter of the ceramic foam or fibrous material type.

According to a first feature of the method of the invention, the engine is supplied with a fuel containing a catalyst intended to lower the combustion temperature of the soot held in the PF. That itself is in fact a known technique already mentioned above, known as “fuel borne catalysis” or FBC in which technique the fuel incorporates a catalytic additive which, after the fuel has been burnt in the engine, becomes incorporated into the soot and will allow combustion of the soot to be initiated at a temperature lower than the temperature at which the soot normally burns.

In the case of the present invention, this additive present in the fuel consists essentially either of an iron compound or of an iron compound combined with a cerium compound. What “consists essentially of” means is that the additive contains no compound with a catalytic action other than the iron compound or the iron and cerium compounds. This additive may thus contain other compounds but, if it does, these compounds have no catalytic function and play no part in lowering the temperature at which the soot burns.

By way of iron compounds mention may, by way of example, be made of compounds of the ferrocene type, ferrous and ferric acetylacetonates, iron naphthenate, iron oleate, iron octoate, iron stearate, iron neodecanoate, iron alkenyl and alkyl succinates and more generally the iron salts of C6-C24 carboxylic acids.

By way of cerium compound, mention may likewise and by way of example be made of cerium acetylacetonates, cerium naphthenate, cerium oleate, cerium octoate, cerium stearate, cerium neodecanoate, cerium alkenyl and alkyl succinates and more generally the cerium salts of C6-C24 carboxylic acids.

This additive may be in the form of an aqueous or organic solution of an iron compound or of a cerium compound.

This additive may also be in the form of an organic colloidal dispersion of an iron compound or of a cerium compound. In this case, this iron compound or cerium compound may more particularly be an oxide and/or a hydroxide and/or an oxyhydroxide of iron or of cerium.

The expression “colloidal dispersion” in this description denotes any system consisting of fine solid particles of colloidal dimensions based on an iron compound or on a cerium compound, in stable suspension in a liquid phase, it being further possible for said particles possibly to contain residual quantities of bonded or adsorbed ions such as, for example, nitrates, acetates, citrates or ammoniums. What is meant by colloidal dimensions is dimensions comprised between about 1 nm and about 500 nm. The particles may more particularly have a mean size of about 250 nm at most, particularly 100 nm at most, preferably 20 nm at most and more preferably still 15 nm at most. It will be noted that, in such dispersions, the iron compound or the cerium compound may either, and preferably, be completely in the form of colloids or may be in the form of colloids and partially in the form of ions.

The particle sizes mentioned hereinabove and for the remainder of the description are, unless indicated otherwise, determined by transmission electron microscopy (TEM), in the conventional way, on a specimen dried beforehand and deposited on a carbon membrane supported on a copper grating.

It will be noted here that, for the embodiment of the invention in which use is made of an iron compound in combination with a cerium compound, this may first of all be a mixture of these compounds, for example an iron salt mixed with a cerium salt or may alternatively be a colloidal dispersion containing colloids of the iron compound and colloids of the cerium compound. It may also be compounds of a hybrid type, that is to say compounds in which the iron and the cerium are present together in the same chemical species. It may, for example, be mixed iron and cerium salts or colloidal dispersions in which the colloids are mixed oxides of iron and of cerium.

Still in the case of the embodiment using an iron compound in combination with a cerium compound, the proportion of iron and of cerium may vary in a ratio ranging from 0/100 to 80/20, this ratio being a molar ratio of Ce element with respect to Fe element. This ratio may more particularly be comprised between 10/90 and 50/50.

According to one particular embodiment of the invention, the method is implemented with an additive which essentially comprises only an iron compound.

According to another particular embodiment of the invention, the colloidal dispersion is a dispersion which contains an organic phase; particles of an iron compound in amorphous form and at least one amphiphilic agent.

A dispersion such as this is described in patent application WO 03/053560 A1 to the teachings of which reference may be made and the essential features of which are summarized hereinbelow.

The particles of this dispersion are based on an iron compound which, preferably, may be amorphous. This amorphous nature may be demonstrated by X-ray analysis, the X-ray diagrams obtained indeed in this case showing no significant spike.

The iron compound is an oxide and/or a hydroxide and/or an oxyhydroxide of iron. The iron is generally present essentially in oxidation state 3.

According to an alternative form, at least 85%, more particularly at least 90% and more particularly still at least 95% of the particles are primary particles. What is meant by a primary particle is a particle which is perfectly individualized and has not clumped together with any other particle or particles. This feature may be demonstrated by examining the dispersion using TEM.

Further, and according to an advantageous alternative form, the particles in this colloidal dispersion may have a fine particle size, that is to say a d₅₀ comprised between 1 nm and 5 nm, more particularly between 3 nm and 4 nm.

As mentioned above, the particles in the colloidal dispersion are in suspension in an organic phase which may be chosen from aliphatic hydrocarbons, chlorinated hydrocarbons or mixtures thereof.

The amphiphilic compound may be a carboxylic acid generally containing 10 to 50 carbon atoms, preferably 15 to 25 carbon atoms and may be a linear or branched acid. It may be chosen from aryl acids, aliphatic acids or arylaliphatic acids.

By way of example, mention may be made of the fatty acids of tall oil, soybean oil, tallow, linseed oil, oleic acid, linoleic acid, stearic acid and isomers thereof, pelargonic acid, capric acid, lauric acid, myristic acid, dodecylbenzenesulfonic acid, 2- ethylhexanoic acid, naphthenic acid, hexanoic acid, toluenesulfonic acid, toluenephosphonic acid, laurylsulfonic acid, laurylphosphonic acid, palmitylsulfonic acid, and palmitylphosphonic acid.

The amphiphilic compound may also be chosen from polyoxyethylene alkyl ether phosphates or alternatively dipolyoxyethylene alkyl phosphates or polyoxyethylene alkyl ether carboxylates.

By way of a colloidal dispersion of cerium that can be used in the context of the present invention, mention may be made of the one described in EP-A-671205. This dispersion comprises particles of cerium oxide, an amphiphilic acid compound and an organic phase, of the kind of those described hereinabove, and is characterized in that the particles have a d₉₀ at most equal to 200 nanometers. The dispersion also has at least one of the following features: (i) the particles of cerium oxide are in the form of clumps of crystallites of which the d₈₀, advantageously the d₉₀, measured by photometric counting (high resolution transmission electron microscopy) is at most equal to 5 nanometers, ninety percent (by mass) of the clumps containing 1 to 5, preferably 1 to 3, crystallites, (ii) the amphiphilic acid compound contains at least one acid involving 11 to 50 carbon atoms, having at least one branching in the alpha, beta, gamma or delta position with respect to the atom carrying the acidic hydrogen.

Reference may also be made to the teaching of WO 97/19022 which describes colloidal dispersions of cerium that can be used here in combination with a colloidal dispersion of iron but which also describes colloidal dispersions of a mixed compound of iron and of cerium which can therefore be used also as such for the invention. The dispersions described in WO 97/19022 contain particles of a compound of cerium and/or of iron, an amphiphilic acid compound and an organic phase as described hereinabove and are characterized in that the particles are obtained by a method involving the following steps: a) preparing a solution containing at least one soluble salt, usually an acetate and/or a chloride, of cerium; b) bringing the solution into contact with a basic medium and keeping the reaction mixture thus formed at a basic pH; c) recovering the precipitate formed using atomization or lyophilization.

By way of colloidal dispersions of cerium that can be used here in combination with a colloidal dispersion of iron but also by way of colloidal dispersions of a mixed compound of iron and of cerium that can be used as such in the invention, mention may also be made of those described in WO 01/10545. These organic colloidal dispersions contain particles of a cerium compound and possibly of an iron compound in a cerium proportion which is preferably at least 10 mol%, more particularly at least 20 mol%, and more particularly still, at least 50 mol% with respect to the total number of moles of Fe+Ce elements expressed as oxide. These dispersions contain at least one acid, preferably an amphiphilic acid, and at-least one diluent, preferably a nonpolar diluent, these being of the type described above. These dispersions are such that at least 90% of the particles are monocrystalline. The particles may also have a d₅₀ comprised between 1 and 5 nm, preferably between 2 and 3 nm.

The additive may be contained in an auxiliary tank and added to the fuel in the requisite quantity by known means. This quantity, expressed as mass of metallic iron element with respect to the mass of fuel, may for example be comprised between 0.5 ppm and 25 ppm, more particularly between 2 ppm and 15 ppm, and more particularly still, between 2 ppm and 10 ppm.

According to a second feature of the method of the invention, the exhaust gases from the engine are passed through a catalytic PF.

The catalyst in this filter consists of a catalyst that assists with the burning of the particles of soot. What is meant by “consists of” is that the catalyst has no function other than to assist with the combustion of soot and that the PF does not contain any other catalyst.

This assistance with the combustion of soot may be direct insofar as the catalyst may promote this combustion by lowering the combustion temperature, or indirect insofar as the catalyst contributes to the propagation of a high temperature from the area at which combustion of soot begins throughout the bed of soot deposited on the PF.

This PF catalyst may be a catalyst based on at least one metal chosen from platinum or metals from the platinum group, such as palladium for example. Combinations of platinum with these metals or alternatively of these metals with one another are of course possible.

The metal of the catalyst may be incorporated into the filter or deposited thereon in a known way. It may, for example, be included in a coating (washcoat) itself deposited on the filter. This coating may be chosen from alumina, titanium oxide, silica, spinels, zeolites, silicates, crystalline aluminum phosphates or mixtures thereof. Alumina may quite especially be used.

Insofar as the catalyst of the PF is a catalyst that assists with the burning of soot, it is therefore present on the filter in a relatively small quantity, that is to say in general in a quantity of at most 70 g/foot³ (2.5 g/dm³). This quantity is expressed as mass of metal element, for example as mass of platinum, with respect to the volume of the PF. This quantity may more particularly be at most 60 g/foot³ (2.1 g/dm³) and more particularly still, at most 50 g/foot³ (1.8 g/dm³). It may, for example, be comprised between 20 g/foot³ (0.7 g/dm³) and 50 g/foot³, particularly between 20 and 40 g/foot³ (1.4 g/dm³).

According to an alternative form of the invention, it is possible for the exhaust gases to be passed over a diesel oxidation catalytic converter positioned upstream (with respect to the direction in which the gases flow) of the PF. The function of a catalytic converter such as this is to convert the hydrocarbons and CO contained in the gases into CO₂ and water vapor. The catalytic converters capable of fulfilling this function are known and are generally based on platinum, palladium, rhodium and mixtures thereof, these metals being deposited on supports of the alumina, titanium oxide, silica type, in pure or doped form.

As the method of the invention can operate at low temperature, it is possible to implement it on a motor fitted with an exhaust system comprising a system for reducing oxides of nitrogen (NOx) of the deNOx type. According to a first alternative form, this system may include means for the selective reduction of the oxides of nitrogen, for example by treating them with ammonia. In this case, the system comprises a catalytic converter, for example of the type based on vanadium on a support of the titanium oxide type, or alternatively based on a metal of the iron or copper type in a zeolite. According to a second alternative form, this system may include NOx traps which store the NOx in a lean medium and reduce them in a rich medium. These NOx traps are, for example, compositions based on barium and platinum on an alumina support. This system may be positioned upstream of the PF and close to the engine in order to have the hottest possible gases across the deNOx catalytic converter (a close-coupled system) or alternatively downstream of the PF because the temperature of the gases leaving the PF, in particular during regeneration, is lower than in systems of the prior art.

Examples will now be given.

### EXAMPLE 1

This example relates to results obtained on a touring vehicle equiped with a direct-injection turbocharged (TDI) 5-cylinder diesel engine with a capacity of 2460 cm³, developing a maximum power of 128 kW and a maximum torque of 400 nm.

The vehicle exhaust system includes a diesel oxidation catalytic converter made up of a 1.2-liter cordierite monolith containing platinum (110 g/foot³(3.9 g/dm³)) and an alumina-based washcoat. A silicon carbide PF (200 cpsi) with a volume of 2.9 liters is mounted downstream of the diesel oxidation catalytic converter in the exhaust system. This PF includes on its filtering walls a washcoat containing platinum in a content of 40 g/foot³ (1.4 g/dm³) and alumina in order to disperse the Pt and cause it to adhere to the filter.

Tests were carried out by making the vehicle perform a so-called “urban” driving cycle during which the engine speed was limited to 1500 rpm, leading to a mean gas temperature entering the PF of 240° C. The driving cycle, lasting a total of 44 minutes, was such that the temperature of the exhaust gases entering the PF reached a value of 300° C. or higher for just 8% of the time. The driving cycle was performed 15 times, representing eleven hours of driving, in order to reach a certain pressure drop across the PF, expressed as a percentage of the maximum pressure drop acceptable for system operation.

A test was carried using a diesel-oil fuel containing no additive (FBC additive) for catalyzing the combustion of soot and another test was performed in which the diesel-oil fuel contained, by way of FBC additive, a colloidal dispersion of iron in a quantity of 7 ppm by mass of metal iron. This dispersion contained 10 wt % of metal iron, isostearic acid in Isopar L and was prepared in accordance with the teachings of WO 03/053560.

Table 1 below quotes the fill percentage of the PF, 100% corresponding to the maximum pressure drop compatible with system operation.

TABLE 1

| | Catalytic PF and | Catalytic PF and |
|---|---|---|
| | fuel containing FBC | fuel with no FBC |
| | additive (invention) | additive (comparative) |
| PF fill % after | 22% | 45% |
| 11 hours of driving | | |

It can be seen that, under unfavorable conditions, that is to say in an urban cycle during which the temperature of the exhaust gases remains low, the method of the invention makes it possible to slow down the buildup of soot in the filter by approximately 50% and therefore delay the filter regeneration operation. The faster burning of soot due to the method of the invention has actually made it possible, during the short periods in the cycle where the temperature of the gases is at its highest, to burn a far greater quantity of soot than is burnt in the comparative method.

### EXAMPLE 2

This example gives the results of tests performed with the same engine as in example 1 but mounted on an engine test rig so as to measure the balance point defined as the temperature at which the system is able to burn soot at the same rate at which the soot is produced by the engine. This balance point is determined through the temperature that has to be applied at the inlet to the PF in order to stabilize the pressure drop across it.

The exhaust system in this case consists only of the PF described in example 1. Two tests were performed with this catalytic filter: a first test with the diesel-oil fuel with no FBC additive and a second test with a fuel containing FBC additive, that is to say containing 5 ppm by mass of metal iron from the same colloidal dispersion as was used in example 1. A third test was performed using the same fuel containing FBC additive (5 ppm by mass of metal iron with the same dispersion) but with a silicon carbide PF containing no catalytic material.

The following procedure was used to measure the balance point: The filters were filled over approximately 8 hours so as to achieve a backpressure of 94 mbar across all three systems, corresponding to 16 g of soot. Filling was performed by applying an engine speed of 3000 revolutions/minute, a torque of 40 Nm, which corresponded to a filter inlet temperature of 200° C.

Once the filter became full, the engine speed was reduced to 2000 revolutions/min then the torque was gradually increased from 45 Nm every 15 minutes until the pressure drop across the filter was balanced (the balance point was reached).

Table 2 quotes the balance point temperatures measured for the three tests.

TABLE 2

| | Catalytic PF | Catalytic PF | Non-catalytic |
|---|---|---|---|
| | and fuel | and fuel with | PF and fuel |
| | containing FBC | no FBC | containing |
| | additive | additive | FBC additive |
| | (invention) | (comparative) | (comparative) |
| Engine | 91 | 125 | 97 |
| torque | | | |
| (Nm) | | | |
| Balance | 340° C. | 410° C. | 355° C. |
| point | | | |
| (° C.) | | | |

It can be seen that the method according to the invention gives a balance point at a lower temperature, which results in better effectiveness in the burning of soot at low temperature.

### EXAMPLE 3

This example gives the results of measuring the speed of regeneration of the soot at a fixed PF inlet temperature.

Two tests were performed with the catalytic filter, the first using a diesel-oil fuel with no FBC additive and the second with a fuel containing FBC additive, that is to say 5 ppm by mass of metal iron from the same colloidal dispersion as was used in example 1. A third test was performed using the same fuel containing as additive 5 ppm by weight of iron metal with the same colloidal dispersion but with a silicon carbide filter containing no catalytic material.

The speed of combustion was measured as follows: the filters were filled over about 8 hours so as to reach a backpressure of 94 mbar across all three systems, corresponding to 16 g of soot. Filling was performed by applying an engine speed of 3000 revolutions/minute, a torque of 40 Nm corresponding to a filter inlet temperature of 200° C. The PF was removed and weighed before and after the soot-filling step, so as to measure the quantity of soot present in the filter before regeneration. The difference in mass of the filter before and after filling gives the mass of soot accumulated during the filling phase.

Once the filter was filled, the engine speed was reduced to 2000 revolutions/min then the torque was set at 170 Nm to reach a PF inlet temperature of 425° C. These conditions were maintained for 1 hour then the PF was removed and weighed again to evaluate the level of soot burnt during regeneration at 425° C. The mass of soot at the end of regeneration (i.e. the mass of unburnt soot) corresponds to the difference in mass of the filter between what was measured at the end of regeneration and the mass of the filter at the start of the test, prior to filling.

The level of soot burnt during regeneration, calculated between the start and end of regeneration, is expressed as a percentage burnt soot using the following expression:

Percentage burnt soot=(mass of soot accumulated during filling−mass of soot at the end of regeneration)/mass of soot accumulated during filling×100.

Table 3 gives these values for the three tests.

TABLE 3

| | Catalytic PF | Catalytic PF | Non-catalytic |
|---|---|---|---|
| | and fuel | and fuel with | PF and fuel |
| | containing | no FBC | containing |
| | FBC additive | additive | FBC additive |
| | (invention) | (comparative) | (comparative) |
| Mass % soot | 50 | 8 | 30 |
| burnt at | | | |
| 425° C. at the | | | |
| inlet to the | | | |
| filter | | | |

It can therefore be seen that the method of the invention makes it possible to improve the rate of combustion of soot over the comparative methods because the level of soot burnt under the conditions of the invention is 50% whereas it is only 8% in the case of the same filter without the additive in the fuel and 30% in the case of the use of a fuel with an additive but with a non-catalytic filter.

1.-10. (canceled)

11. In the operation of a diesel engine or a lean-burn engine equipped with an exhaust system in which a particle filter is mounted, the improvement which comprises supplying the engine with a fuel containing an additive that lowers the combustion temperature of the particles of soot retained by the particle filter and consisting essentially of an iron compound or essentially of an iron compound and of a cerium compound, and that the particle filter through which the exhaust gases produced by the combustion of the fuel in the engine are passed, is a catalytic filter, the catalyst of which assists with the combustion of the particles of soot.

12. The operation as defined by claim 11, wherein the fuel additive comprises an aqueous or organic solution of an iron compound or of an iron compound and of a cerium compound.

13. The operation as defined by claim 11, wherein the fuel additive comprises an organic colloidal dispersion of an iron compound or of an iron compound and of a cerium compound.

14. The operation as defined by claim 13, wherein said colloidal dispersion comprises particles of an iron compound in amorphous state and at least one amphiphilic agent.

15. The operation as defined by claim 13, wherein said colloidal dispersion comprises an iron compound or a cerium compound which is an oxide, a hydroxide or an oxyhydroxide of iron or of cerium.

16. The operation as defined by claim 11, wherein the proportion of iron and of cerium in the fuel additive is within a ratio ranging from 0/100 to 80/20, this ratio being a molar ratio of Ce element with respect to Fe element of from 10/90 to 50/50.

17. The operation as defined by claim 11, wherein the particle filter catalyst is a catalyst based on at least one metal selected from platinum or metals of the platinum group, said metal being included in a coating (washcoat) deposited on the filter and in a quantity of at most 70 g/foot³ (2.5 g/dm³).

18. The operation as defined by claim 17, wherein the quantity of catalyst is at most 50 g/foot³ (1.8 g/dm³).

19. The operation as defined by claim 11, wherein the exhaust gases are passed across a diesel oxidation catalytic converter positioned upstream of the particle filter.

20. The operation as defined by claim 11, wherein the engine is equipped with an exhaust system comprising a nitrogen oxides reduction system.
